(19) United States
(12) Patent Application Publication
(10) Pub. No.: US 2004/0246567 A1
(43) Pub. Date: Dec. 9, 2004

(54) Gain-clamped optical amplifier

(76) Inventors: Joon Tae Ahn, Taejon (KR); Jong Moo Lee, Taejon (KR); Kyong Hon Kim, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/720,220

(22) Filed: Nov. 25, 2003

(30) Foreign Application Priority Data
Jun. 9, 2003 (KR) 2003-36795

(51) Int. Cl. H01S 3/00

(52) U.S. Cl. 359/337

(57) ABSTRACT

A gain-clamped optical amplifier including: optical reflection means installed on an input optical fiber or an output optical fiber; optical anti-reflection means installed on the optical fiber opposite to the optical fiber having the optical reflection means installed on; and an optical amplifier located between the optical reflection means and the optical anti-reflection means, for amplifying an input signal or an output signal, wherein an amplified spontaneous emission light emitted from the optical amplifier to the input optical fiber and the output optical fiber is reflected by the optical reflection means and amplified in the optical amplifier.

### BACKGROUND OF THE INVENTION

1. Field of the Invention

The present invention relates to a gain-clamped optical amplifier, and more particularly, to a gain-clamped optical amplifier in which reflection means such as an optical fiber Bragg grating, etc. is used at an input terminal or an output terminal of a semiconductor-optical amplifier so that a constant gain characteristic is provided despite a variation of an input signal power.

2. Discussion of the Related Art

Generally, an optical amplifier is an optical element for amplifying the intensity of an input optical signal. When an optical signal is transmitted and an optical network is constructed, the optical amplifier is used to compensate an optical loss generated from a transmitting optical fiber and various optical elements. A semiconductor-optical amplifier and an optical fiber amplifier are widely used.

Particularly, since the semiconductor-optical amplifier and the optical fiber amplifier have a characteristic of an excellent non-linear optical effect, they are widely utilized as the optical element for signal process, such as an optical switch, a wavelength converter, etc. as well as for optical amplification. However since the semiconductor-optical amplifier and the optical fiber amplifier have a drawback in that a communication quality is not good in the optical network since they have an amplification characteristic varied depending on the input optical signal power. To solve the drawback, a gain-clamped optical amplifier has been disclosed.

Since a conventional full light gain-clamped optical amplifier using a laser cavity to optically clamp a gain does not have a complicated signal process for clamping the gain, it has been widely studied and developed.

A laser oscillation occurs when the loss and the gain generated from a cavity are identical with each other, and once the laser oscillation occurs, a magnitude of a population inversion in a gain medium is clamped.

Since the gain of the optical amplifier is proportional to the magnitude of the population inversion and a length of the gain medium, if the laser oscillation occurs, the gain of the optical amplifier can be clamped.

Similarly, the optical amplifier having the gain clamped by the laser oscillation has a characteristic in which when the input signal is amplified, in case the input signal power is decreased, the gain is constantly maintained regardless the input signal power, and in case the input signal power is gradually increased, the laser oscillation is stopped and the gain clamp of the optical amplifier is lost.

A conventional gain-clamped semiconductor-optical amplifier is disclosed in U.S. Pat. Nos. 5,991,068 and 6,249,373.

FIG. 1 illustrates the conventional gain-clamped semiconductor-optical amplifier disclosed in U.S. Pat. No. 5,991,068. The conventional semiconductor-optical amplifier (SOA) includes the cavity using a distributed Bragg reflector (DBR) at both sides of a gain section to have the laser oscillation obtained from a wavelength reflected by the Bragg reflector. If the input signal is incident on the gain-clamped semiconductor-optical amplifier, the optical amplifier has a mutual assistant relation formed between the input signal power amplified and a laser signal power oscillated therein to constantly maintain the gain.

In other words, in case the input signal power is decreased, the laser oscillation power is increased, and to the contrary, in case the input signal power is gradually increased, the laser oscillation power is gradually decreased and outputted. Accordingly, even though the input signal power is varied to some extent, the gain-clamped semiconductor-optical amplifier functions having a constant amplification ratio, however if the input signal power is more increased, the laser oscillation is stopped and the gain is gradually decreased as in the general optical amplifier.

Similarly, in the gain-clamped optical amplifier, when a gain value is constantly clamped, the input signal power having a small value of 3 dBm is called as a saturation input power. The gain-clamped optical amplifier can provide a constant gain for the input signal power less than the saturation input power regardless the variation of the input signal power.

FIG. 2 illustrates the gain-clamped optical fiber amplifier disclosed in U.S. Pat. No. 6,249,373. An erbium-doped fiber is used as the gain medium of the optical fiber amplifier, and a pump light is supplied through a wavelength divisional multiplexer (WDM). At the input/output terminal of the optical amplifier, a ring cavity for laser oscillation is formed including an attenuator (ATT), an isolator (ISO) and a band pass filter (BPF) connected by a coupler. The band pass filter is to control a wavelength generating the laser oscillation, the isolator is to oscillate in only one direction in the ring cavity, and the attenuator is to control the optical loss of the cavity to control the gain of the optical amplifier.

However, in the conventional gain-clamped optical amplifier using the laser cavity shown in FIGS. 1 and 2, in case the input signal power is varied, a temporary output fluctuation is generated from the input signal power amplified due to a relaxation oscillation phenomenon being a characteristic of the laser. The temporary variation in the input signal power causes a bit error rate of transmitted data to be deteriorated. Further, a relaxation oscillation frequency is determined depending on a gain medium characteristic, a cavity length, etc., and causes a signal transmission speed and a signal process speed to be limited.

### SUMMARY OF THE INVENTION

Accordingly, the present invention is directed to a gain-clamped optical amplifier that substantially obviates one or more problems due to limitations and disadvantages of the related art.

An object of the present invention is to provide a full light gain-clamped optical amplifier not needing a laser cavity in which, at the time of an amplification and a signal process due to a relaxation oscillation phenomenon generated in a conventional full light gain-clamped optical amplifier using the laser cavity, performance deterioration can be prevented, and in which a gain-clamped characteristic can be obtained even by an earlier manufactured optical amplifier as well as owing to a simplified construction, it is easy to be embodied.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a gain-clamped optical amplifier including: optical reflection means installed on an input optical fiber or an output optical fiber; optical anti-reflection means installed on the optical fiber opposite to the optical fiber having the optical reflection means installed on; and an optical amplifier located between the optical reflection means and the optical anti-reflection means, for amplifying an input signal or an output signal, wherein an amplified spontaneous emission light emitted from the optical amplifier to the input optical fiber and the output optical fiber is reflected by the optical reflection means and amplified in the optical amplifier.

The optical reflection means can use one or more optical fiber Bragg gratings and one or more waveguide type Bragg gratings directly engraved on an input optical waveguide of the semiconductor-optical amplifier. Further, even though the optical reflection means uses a wavelength division multiplexer and a mirror installed at an end of the wavelength division multiplexer, the same optical reflection effect can be obtained.

Even though the optical anti-reflection means uses an isolator, an optical fiber having a section of the output optical fiber coated for anti-reflection, and an optical fiber having a core section of the output optical fiber cut slantingly.

In another aspect of the present invention, a gain-clamped optical amplifier includes: a first optical fiber Bragg grating installed on an input optical fiber; a second optical fiber Bragg grating installed on an output optical fiber; and an optical amplifier located between the first optical fiber Bragg grating and the second optical fiber Bragg grating, for amplifying an input signal, wherein amplified spontaneous emission lights emitted from the optical amplifier to the input optical fiber and the output optical fiber are respectively reflected from the first optical fiber Bragg grating and the second optical fiber Bragg grating toward the optical amplifier, and the first optical fiber Bragg grating and the second optical fiber Bragg grating respectively have a central wavelength and a reflection bandwidth different from each other.

The first optical fiber Bragg grating and the second optical fiber Bragg grating can obtain the same effect, though a plurality of waveguide type Bragg grating is directly engraved with a central wavelength and a reflection bandwidth being overlapped to each other, on each of the input/output waveguide of the semiconductor-optical amplifier.

The first optical fiber Bragg grating can use an optical fiber having a section of the output optical fiber coated for anti-reflection, and an optical fiber having a core section of the output optical fiber cut slantingly.

In a further another aspect of the present invention, a gain-clamped optical amplifier includes: an optical reflection means provided at a side wall of any one of an input side and an output side of an optical amplifier; an optical anti-reflection means provided at an opposite side wall to the side wall having the optical reflection means; and the optical amplifier disposed between the optical reflection means and the optical anti-reflection means, for amplifying an input optical signal or an output optical signal, wherein the optical reflection means reflects an amplified spontaneous emission light emitted from the optical amplifier to the input and output sides, on the optical amplifier for amplification.

The optical reflection means is a wavelength selection reflective mirror, and the optical anti-reflection means is an anti-reflective thin film. Even though the wavelength selection reflective mirror and the anti-reflective thin film are respectively coated on the side walls of the input and output sides of the optical amplifier, the spontaneous emission light can be reflected on the wavelength selection reflective mirror for amplification, and to the contrary, the reflection of the spontaneous emission light can be prevented by the anti-reflective thin film.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a construction of a gain-clamped optical amplifier using a conventional semiconductor-optical amplifier;

FIG. 2 illustrates a construction of a gain-clamped optical amplifier using a conventional erbium-doped optical fiber;

FIGS. 3 to 4 illustrate various exemplary constructions of a gain-clamped optical amplifier using an inventive semiconductor-optical amplifier and reflection means;

FIG. 5 illustrates a graph showing a gain and noise characteristic depending on an input signal power in case an optical fiber Bragg grating is used as reflection means in a gain-clamped semiconductor-optical amplifier according to the present invention;

FIG. 6 illustrates a graph showing a spectrum variation characteristic depending on a power variation of the input signal in case an optical fiber Bragg grating being reflection means is installed in an input terminal in a gain-clamped semiconductor-optical amplifier according to the present invention;

FIG. 7 illustrates a graph showing an amplification characteristic every wavelength depending on a power variation of the input signal in case an optical fiber Bragg grating being reflection means is installed in an output terminal in a gain-clamped semiconductor-optical amplifier according to the present invention; and

FIG. 8 illustrates a graph showing an amplification characteristic depending on a power variation of an input optical in a gain-clamped semiconductor-optical amplifier according to the present invention.

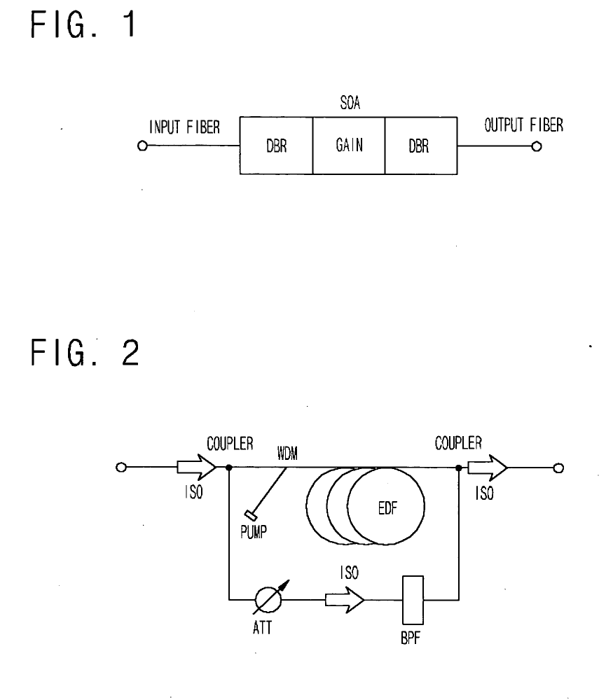

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

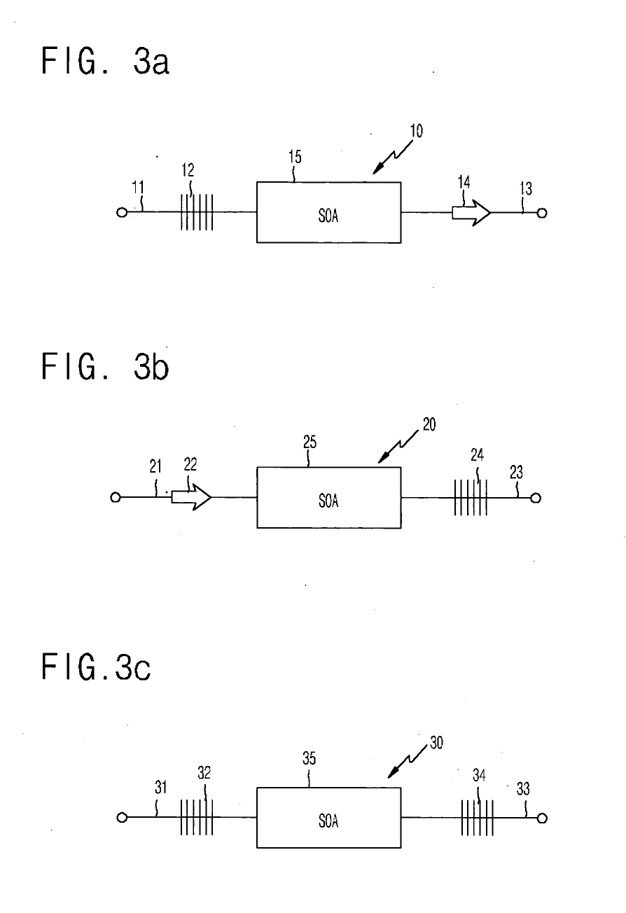

A gain-clamped optical amplifier 10 exemplified in FIG. 3A has a construction in which an optical fiber Bragg grating 12 being reflection means is installed on an input optical fiber 11, an isolator 14 being optical anti-reflection means is installed on an output optical fiber 13, and a semiconductor-optical amplifier 15 is installed between the optical fiber Bragg grating 12 and the isolator 14.

In an embodiment of the present invention, one or more optical fiber Bragg gratings 12 can be installed on and used in the input optical fiber 11, and in another embodiment, even though instead of the optical fiber Bragg grating 12, one or more Bragg gratings are directly engraved on an optical waveguide at the input terminal side of the semiconductor-optical amplifier 15, the same reflective effect can be obtained as in the optical fiber Bragg grating 12.

Further, even though instead of the isolator 14 used as the optical anti-reflection means, in order to prevent a reflected signal from being reflected, an optical fiber is used having a section of the output optical fiber 13 coated or an optical fiber is used having the section of the output optical fiber 13 cut slantingly, the laser oscillation can be prevented from occurring due to the reflected signal emitted from the semiconductor-optical amplifier 15.

In the gain-clamped optical amplifier 10 according to the present invention, if a current is applied to the semiconductor-optical amplifier 15, an amplified spontaneous emission light (Hereinafter, referred to as “ASE”) amplified in the semiconductor-optical amplifier 15 is respectively emitted toward an input optical fiber 11 and an output optical fiber 13. A portion of the ASE emitted to the input optical fiber 11 is reflected from the optical fiber Bragg grating 12 and forwarded toward the semiconductor-optical amplifier 15, and the reflected ASE is amplified together with the input signal in the semiconductor-optical amplifier 15 and thus is outputted through the output optical fiber 13.

Herein, a power of a reflected signal reflected from the optical fiber Bragg grating 12 is proportional to the power of the ASE, and the more the input signal power incident for being amplified in the semiconductor-optical amplifier 15 is increased, the more the power of the ASE is decreased.

In other words, if the input signal power is decreased, the power of the ASE is increased thereby increasing a reflected signal reflected from the optical fiber Bragg grating 12, and to the contrary, if the power of the incident signal is increased, the power of the ASE is decreased thereby decreasing the power of the reflected signal reflected from the optical fiber Bragg grating 12. Resultantly, the input signal and the reflected signal are amplified while the gain of the semiconductor-optical amplifier 15 is divided and used.

At this time, since the input signal power and the reflected signal power are contrary to each other, until the input signal power is increased over some extent, the gain of the semiconductor amplifier 15 is almost constantly maintained while if the input signal power is more increased, the gain of the semiconductor-optical amplifier 15 is decreased.

FIG. 3B exemplifies the gain-clamped optical amplifier 20 in which, contrary to the construction of FIG. 3A, the isolator 22 being the optical anti-reflection means is installed on the input optical fiber 21, and the optical fiber Bragg grating 24 being the optical reflection means is installed on the output optical fiber 23.

In the gain-clamped optical amplifier 20, if the current is applied to the semiconductor-optical amplifier 25, the ASE is respectively emitted toward the input optical fiber 21 and the output optical fiber 23. The ASE emitted toward the output optical fiber 23 is reflected from the optical fiber Bragg grating 24 and forwarded toward the semiconductor-optical amplifier 25, and thus the reflected ASE is amplified together with the input signal in the semiconductor-optical amplifier 25 and thus is cut off by the isolator 22 thereby being lost.

The gain-clamped optical amplifiers 10 and 20 respectively disclosed in FIGS. 3A and 3B are differentiated just only in that the ASE emitted from the semiconductor-optical amplifier is respectively reflected toward the semiconductor-optical amplifier at an input side of FIG. 3A and at an output side of FIG. 3B, and they all have the same optical amplifier characteristic of the clamped gain.

The gain-clamped optical amplifiers 10 and 20 disclosed in FIGS. 3A and 3B are described for the case in which the semiconductor-optical amplifiers 15 and 25 are used as the gain media, however even though instead of the semiconductor-optical amplifiers 15 and 25, an erbium-doped optical fiber amplifier or a rare earth ion doped optical fiber amplifier optically pumped is used, the same amplification effect can be obtained.

Even though the optical fiber Bragg gratings 12 and 24 respectively installed on the input/output optical fibers in FIGS. 3A and 3B are directly engraved as one or more waveguide type Bragg gratings on the light waveguide at the input/output terminal sides of the semiconductor-optical amplifier, the same effect can be obtained.

The isolators 14 and 22 disclosed in FIGS. 3A and 3B are to cut off the reflected signal reflected from an end of the optical fiber and returned toward the semiconductor-optical amplifiers 15 and 25, and if the isolator does not exist, the laser oscillation can occur in the wavelength reflected from the input side optical fiber Bragg grating 12 or from the output side optical fiber Bragg grating 24. Accordingly, in case the input optical fibers 11 and 21 is used as the nonreflecting-coated optical fiber or as the optical fiber being cut to have a slant section, not vertical section with respect to a central axis of an optical fiber core, even though the isolator is, omitted, the same optical anti-reflection effect can be obtained.

In case the optical fiber is cut to have a slant end for anti-reflection, it is desirable that the optical fiber is cut to have the slant end with a slant angle of about 50° so that a reflective light is not wave-guided in the end of the optical fiber. As the slant angle is gradually increased, the anti-reflection effect is gradually increased, however on the contrary, when the optical fiber is coupled with other optical elements, since a coupling efficiency is fallen, it is not preferable to increase the slant angle too much. Accordingly, it is desirable to cut the optical fiber to maintain the slant angle in the end of the optical fiber between 5° and 15°.

FIG. 3C exemplifies the gain-clamped optical amplifier 30 in which a first optical fiber Bragg grating 32 is installed on the input optical fiber 31 and a second optical fiber Bragg grating 34 installed on the output optical fiber 33.

The first optical fiber Bragg grating 32 installed in the gain-clamped optical amplifier 30 allows the ASE forwarding from the semiconductor-optical amplifier 35 toward the input optical fiber 31 to be reflected therefrom and thus be incident on the optical amplifier, and further, the second optical fiber Bragg grating 34 allows the ASE forwarding from the semiconductor-optical amplifier 35 toward the output optical fiber 33 to be reflected therefrom and thus be incident on the optical amplifier. In this case, in comparison with the construction of having the grating located only at one side, since the stronger ASE can be incident on the semiconductor-optical amplifier, the input signal power having the clamped gain can be increased.

In the first and second optical fiber Bragg gratings 32 and 34, a central wavelength and a reflection bandwidth are respectively differently designed not to form the laser cavity due to two gratings so that the object of the present invention can be accomplished.

The gain-clamped optical amplifier 30 disclosed in FIG. 3C is described for the case in which the semiconductor-optical amplifier 35 is used as the gain medium, however even though instead of the semiconductor-optical amplifier 35, the erbium-doped optical fiber amplifier or the rare earth ion doped optical fiber amplifier optically pumped is used, the same amplification effect can be obtained.

Even though the first and second optical fiber Bragg gratings 32 and 34 respectively installed on the input/output optical fibers 31 and 33 in FIG. 3C are directly engraved as one or more waveguide type Bragg gratings on the light waveguide at the input/output terminal sides of the semiconductor-optical amplifier 35, the same effect can be obtained.

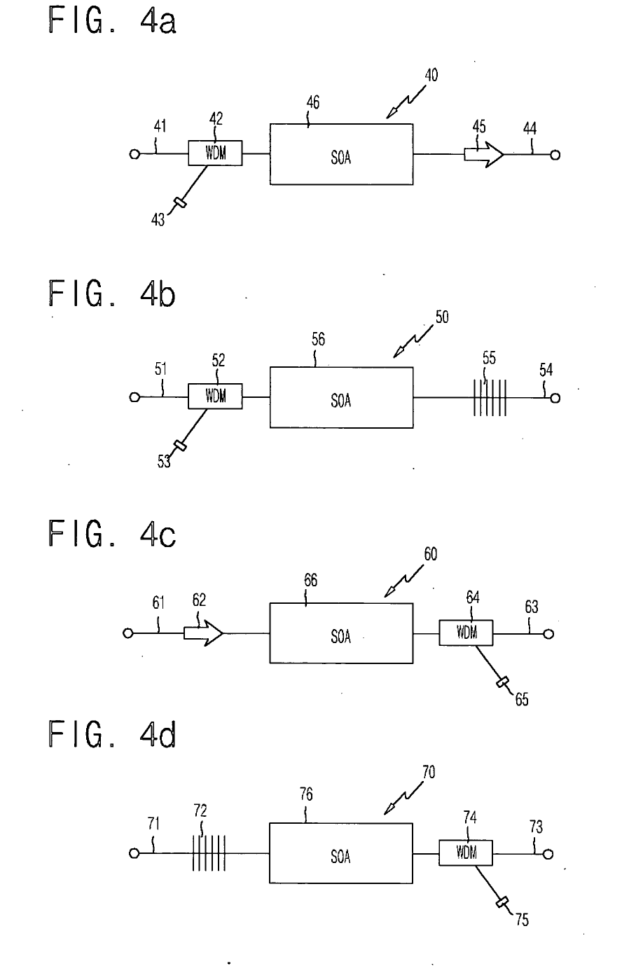

FIG. 4 illustrates exemplary various embodiments of the gain-clamped optical amplifier in which the wavelength division multiplexer (WDM), the isolator and the optical fiber Bragg grating are arranged in the input optical fiber and the output optical fiber.

The gain-clamped optical amplifier 40 exemplified in FIG. 4A has a construction in which, instead of the optical fiber Bragg grating 12 exemplified in FIG. 3A, the wavelength division multiplexer (WDM) 42 is installed on the input optical fiber 41 to allow a wavelength band of the input signal and a wavelength band of the reflected signal to be separated from each other, and in which a mirror 43 is installed on the input optical fiber 41 through which the reflected signal forwards, and further in which the isolator 45 is installed on the output optical fiber 44 and the semiconductor-optical amplifier 46 is installed between the wavelength division multiplexer 42 and the isolator 45.

The gain-clamped optical amplifier 40 disclosed in FIG. 4A is described for the case in which the semiconductor-optical amplifier 46 is used as the gain medium, however even though instead of the semiconductor-optical amplifier 46, the erbium-doped optical fiber amplifier or the rare earth ion doped optical fiber amplifier optically pumped is used, the same amplification effect can be obtained.

In the above constructed gain-clamped optical amplifier 40, if the current is applied to the semiconductor-optical amplifier 46, the ASE amplified in the semiconductor-optical amplifier 46 is emitted to each of the input optical fiber 41 and the output optical fiber 44. A portion of the ASE emitted to the input optical fiber 41 is separated as the reflected signal by the wavelength division multiplexer 42 and the separated reflected signal is reflected from the mirror 43 to be amplified together with the input signal in the semiconductor-optical amplifier 46 and thus be outputted through the output optical fiber 44.

A gain-clamped optical amplifier 50 exemplified in FIG. 4B has a construction in which a wavelength division multiplexer 52 is installed on an input optical fiber 51, a mirror 53 is installed on an input optical fiber 51 through which the reflected signal forwards, an optical fiber Bragg grating 55 is installed on an output optical fiber 54, and a semiconductor-optical amplifier 56 is installed between the wavelength division multiplexer 52 and the optical fiber Bragg grating 55.

The gain-clamped optical amplifier 50 exemplified in FIG. 4B is differentiated just only in that, instead of the isolator 45 installed in the gain-clamped optical amplifier 40 of FIG. 4A, the optical fiber Bragg grating 55 is used, and since the rest construction and function is identical with that of FIG. 4A, their related descriptions are omitted in the following description.

A gain-clamped optical amplifier 60 exemplified in FIG. 4C has a construction in which an isolator 62 is installed on an input optical fiber, a wavelength division multiplexer 64 installed on an output optical fiber 63 to allow the wavelength band of the output signal and the wavelength band of the reflected signal to be separated from each other, a mirror 65 is installed on the output optical fiber 63 through which the reflected signal forwards, and a semiconductor-optical amplifier 66 is installed between an isolator 62 and a wavelength division multiplexer 64.

In the above constructed gain-clamped optical amplifier 60, if the current is applied to the semiconductor-optical amplifier 66, the ASE amplified in the semiconductor-optical amplifier 66 are emitted to each of the input optical fiber 61 and the output optical fiber 63. A portion of the ASE emitted to the output optical fiber 63 is separated as the reflected signal by the wavelength division multiplexer 64 and the separated reflected signal is reflected from the mirror 65 to be amplified together with the input signal in the semiconductor-optical amplifier 66 and thus be cut off by the isolator 62 thereby being lost.

A gain-clamped optical amplifier 70 exemplified in FIG. 4D has a construction in which an optical fiber Bragg grating 72 is installed on an input optical fiber 71, a wavelength division multiplexer 74 and a mirror 75 are installed on an output optical fiber 73, a semiconductor-optical amplifier 76 is installed between the optical fiber Bragg grating 72 and the wavelength division multiplexer 74.

The gain-clamped optical amplifier 70 exemplified in FIG. 4D is differentiated just only in that, instead of the isolator 62 installed in the gain-clamped optical amplifier 60 of FIG. 4C, since the optical fiber Bragg grating 72 is used and the rest construction and function is identical with that of FIG. 4C, their related descriptions are omitted in the following description.

The optical fiber Bragg gratings 55 and 72 disclosed in FIGS. 4B and 4D can be installed as one or more identical with the above-described optical fiber Bragg grating, on the optical fiber, and additionally even though one or more waveguide type Bragg gratings are directly engraved on the light waveguide at the input/output terminal sides of the semiconductor-optical amplifier, the same effect can be obtained in which the reflected signal emitted from the semiconductor-optical amplifier can be anti-reflected.

A gain-clamped optical amplifier 80 exemplified in FIG. 4E has a construction in which a wavelength selection thin film mirror 83 for reflecting a desired wavelength bandwidth is coated on any one of side walls of a semiconductor optical amplifier 85 including input/output optical fibers 81 and 82, and an anti-reflective thin film 84 for suppressing a laser oscillation caused by the wavelength selection thin film mirror 83 is coated on the other side wall.

The gain-clamped optical amplifier 80 according to the present invention is differentiated in that the wavelength selection thin film mirror 83 and the anti-reflective thin film 84 are coated on the side walls of the semiconductor optical amplifier 85, unlike the construction in which the ASE reflector or the optical isolator is installed at the input/output optical fiber as shown in FIGS. 3A to 3C and FIGS. 4A to 4D. Further, the present invention can be identically applied even to the erbium doped optical fiber amplifier or the rare earth ion doped optical fiber amplifier optically pumped, instead of the semiconductor optical amplifier 85.

In the inventive gain-clamped optical amplifier 80 as constructed above, if a current is applied to the semiconductor optical amplifier 85, the ASE amplified in the semiconductor optical amplifier 85 is respectively emitted to input/output sides. A portion of the ASE emitted to the input side is reflected on the wavelength selection thin film mirror 83, and the reflected ASE is amplified together with an input optical signal in the semiconductor optical amplifier 85 to be outputted through an output optical fiber 82. At this time, since the anti-reflective thin film 84 suppresses the ASE emitted to the output side, the laser oscillation does not result from the reflective light emitted from the semiconductor optical amplifier 85.

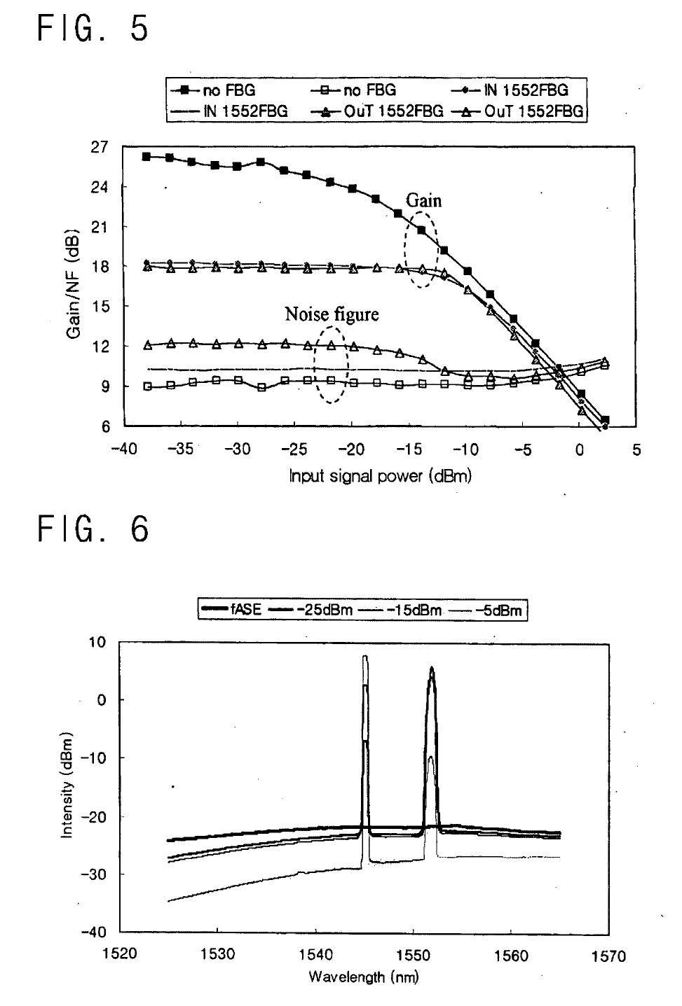

FIG. 5 is a graph showing an experimental result of the gain and a noise figure depending on the input signal power in the inventive gain-clamped semiconductor-optical amplifier and the general semiconductor-optical amplifier.

In an experiment of the gain-clamped optical amplifier according to the present invention, the wavelength of the input signal is 1545 nm, and the optical fiber Bragg grating is used having the central wavelength of about 1551.72 nm, a reflective ratio of about 25 dB and a reflection bandwidth of about 0.5 nm.

A rectangular shape depicted on the graph of FIG. 5 represents a state in which the optical fiber Bragg grating 24 is omitted in the gain-clamped optical amplifier 10 of FIG. 3B, that is, the characteristic of the gain and the noise figure in the general semiconductor-optical amplifier.

A circular shape depicted on the graph FIG. 5 is an experiment result of an amplification characteristic in a state in which the optical fiber Bragg grating 12 is provided at the side of the input optical fiber 11 of the gain-clamped optical amplifier 10 exemplified in FIG. 3A, and a triangular shape is the experiment result of the amplification characteristic in a state in which the optical fiber Bragg grating 24 is provided at the side of the output optical fiber 23 in the gain-clamped optical amplifier 20 of FIG. 3B.

Referring to the graph of FIG. 5, as a result of experimenting on the gain-clamped optical amplifier exemplified according to the present invention, in the general semiconductor-optical amplifier, as the input signal power increases, the gain is continuously decreased, however in the inventive gain-clamped optical amplifier using the optical fiber Bragg grating, almost constant gain characteristic is shown in which the input signal power is 18 dB until about −10 dBm, and resultantly, it can be confirmed through the experiment that a stable gain-clamped optical amplification characteristic can be obtained from the exemplary construction of the present invention.

On the other hand, in all of the gain-clamped optical amplifiers exemplified according to various embodiments of the present invention, the magnitude of the gain is inversely proportional to the power of the reflected signal. Accordingly, the reflection ratio, the reflection wavelength and the reflection bandwidth of the optical fiber Bragg grating can be controlled to control the magnitude of the clamped gain.

It can be appreciated that all of the gain-clamped optical amplifiers exemplified in FIGS. 3A and 3B have the noise characteristics further deteriorated comparing with the general semiconductor-optical amplifier. As described above, deterioration of the noise characteristic is general in all gain-clamped optical amplifiers.

FIG. 6 is a spectrum measured in the output terminal according to the input signal power having the wavelength of 1545 nm in the inventive gain-clamped optical amplifier as in the construction of FIG. 3A.

Referring to FIG. 6, a signal at the wavelength of about 1552 nm represents the reflected signal reflected by the optical fiber Bragg grating to be amplified, and a signal at the wavelength of about 1545 nm represents the input signal amplified. In the drawing, the most bolded line represents the ASE measured in case the optical fiber Bragg grating does not exist in the input terminal, and secondly and thirdly bolded lines and the most fine line represent the spectrums in case the signals of −25 dBm, −15 dBm and −5 dBm are respectively incident on the semiconductor-optical amplifier shown in FIG. 3A. According to the experiment result, it can be appreciated that as the input signal power is increased, the power of the ASE is decreased while the power of the amplified reflected signal is decreased.

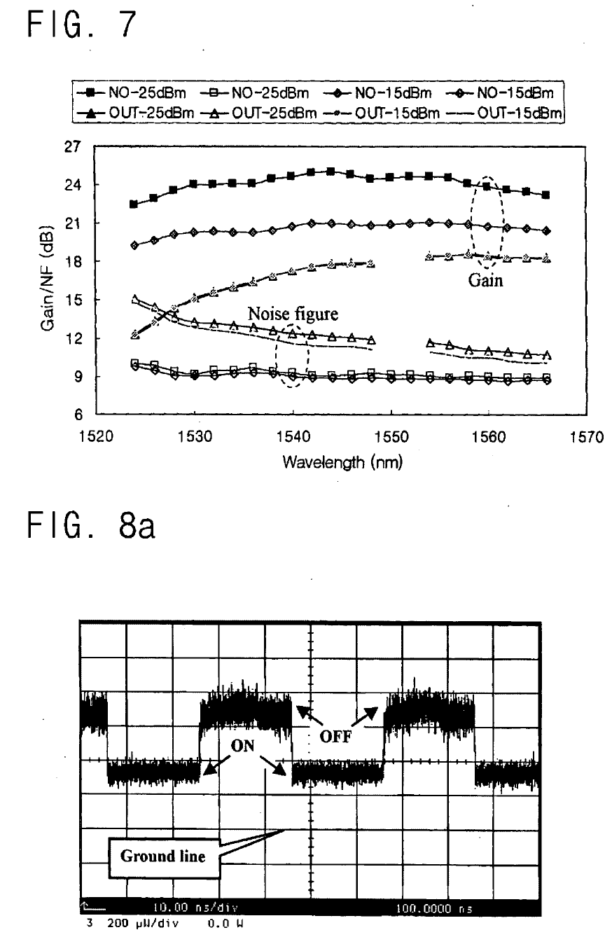

FIG. 7 is a graph showing a result of experimenting the gain and the noise figure according to the input signal power in the inventive gain-clamped semiconductor-optical amplifier of FIG. 3B and the general semiconductor-optical amplifier.

A rectangular shape and a lozenge shape depicted in FIG. 7 are experiment results for the case that the input signal powers of −25 dBm and −15 dBm are incident on the general semiconductor-optical amplifier, and a triangular and a circular shape are experiment results for the case that the input signal powers of −25 dBm and −15 dBm are incident on the inventive gain-clamped optical amplifier in the same condition as in the general semiconductor-optical amplifier.

Referring to FIG. 7, it can be confirmed through the experiment that when the input signal power is gradually increased from −25 dBm to −15 dBm, the general semiconductor-optical amplifier has the gain decreased by about 4 dB every wavelength while the inventive gain-clamped optical amplifier has the same gain every wavelength.

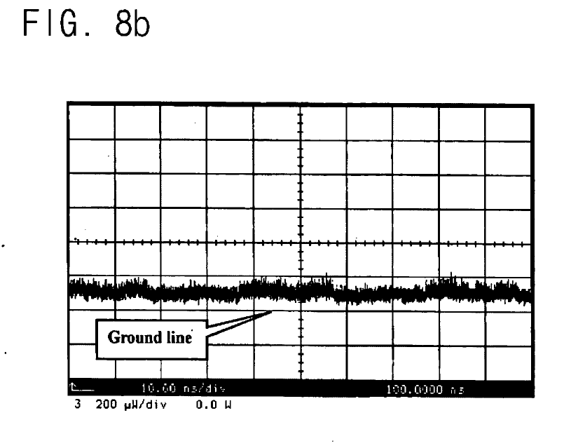

FIGS. 8A and 8B are respectively graphs showing the amplification characteristic according to the variation of the input signal power in the inventive gain-clamped semiconductor-optical amplifier of FIG. 3A and the general semiconductor-optical amplifier.

Referring to FIG. 8, an experiment condition is that after the signal having 1545 nm in a wavelength and −25 dBm in a power and the signal having 1555 nm in the wavelength and −16 dBm in the power are simultaneously incident on the semiconductor-optical amplifier, the 1555 nm wavelength signal is periodically alternatively in an ON or OFF state while the power of the 1545 nm wavelength signal is measured using an oscilloscope. Since the input signal power of −16 dBm corresponds to the power of eight wavelength channel signals having −25 dBm in the input signal power, the experiment results of FIGS. 8A and 8B are almost similar with the case in which eight channel signals among nine wavelength-multiplexed channel signals having −25 dBm in the input signal power are in the ON or OFF state. In the general semiconductor-optical amplifier of FIG. 8A, it can be appreciated that when the 1555 nm wavelength signal is in the OFF state, since the 1545 nm wavelength signal obtains all gains of the amplifier, it is greatly amplified, while when the 1555 nm wavelength signal is in the ON state, since two wavelength signals have the gain divided, the 1545 nm wavelength signal is relatively little amplified.

Therefore, it can be appreciated that the general semiconductor-optical amplifier does not have a gain-clamped characteristic according to the variation of the input signal power, and on the other hand, it can be appreciated through the experiment that the inventive gain-clamped semiconductor-optical amplifier has almost constant power of the 1545 nm wavelength signal regardless the ON or OFF state of the 1555 nm wavelength signal.

As described above, the inventive full light gain-clamped optical amplifier using the reflection means such as the optical fiber Bragg grating, etc. can overcome a disadvantageous relaxation oscillation generated from the conventional full light gain-clamped optical amplifier using the laser cavity, and further can simplify a construction to embody easily in comparison with the conventional manners, and furthermore can utilize even the earlier manufactured optical amplifiers to advantageously obtain the gain clamping characteristic. The gain-clamped optical amplifier according to the present invention can be utilized as the optical transmission process element and the optical amplifier for a metro network.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A gain-clamped optical amplifier comprising:
optical reflection means installed on an input optical fiber or an output optical fiber;
optical anti-reflection means installed on the optical fiber opposite to the optical fiber having the optical reflection means installed on; and
an optical amplifier located between the optical reflection means and the optical anti-reflection means, for amplifying an input signal or an output signal,
wherein an amplified spontaneous emission light emitted from the optical amplifier to the input optical fiber and the output optical fiber is reflected by the optical reflection means and amplified in the optical amplifier.

2. The gain-clamped optical amplifier of claim 1, wherein the optical reflection means is one or more optical fiber Bragg gratings installed on the input optical fiber or the output optical fiber.

3. The gain-clamped optical amplifier of claim 1, wherein the optical reflection means is one or more waveguide type Bragg gratings directly engraved on an input optical waveguide or an output optical waveguide of the optical amplifier.

4. The gain-clamped optical amplifier of claim 1, wherein the optical reflection means is comprised of a wavelength division multiplexer and a mirror installed at an end of the wavelength division multiplexer.

5. The gain-clamped optical amplifier of claim 1, wherein the optical anti-reflection means is an isolator.

6. The gain-clamped optical amplifier of claim 1, wherein the optical anti-reflection means uses an optical fiber having a section of the output optical fiber coated for anti-reflection.

7. The gain-clamped optical amplifier of claim 1, wherein the optical anti-reflection means uses an optical fiber having a core section of the output optical fiber cut slantingly.

8. The gain-clamped optical amplifier of claim 1, wherein the optical amplifier is a semiconductor-optical amplifier.

9. The gain-clamped optical amplifier of claim 1, wherein the optical amplifier is an erbium-doped optical fiber amplifier.

10. The gain-clamped optical amplifier of claim 1, wherein the optical amplifier is a rare earth ion doped optical fiber amplifier optically pumped.

11. A gain-clamped optical amplifier comprising:
a first optical fiber Bragg grating installed on an input optical fiber;
a second optical fiber Bragg grating installed on an output optical fiber; and
an optical amplifier located between the first optical fiber Bragg grating and the second optical fiber Bragg grating, for amplifying an input signal,
wherein amplified spontaneous emission lights emitted from the optical amplifier to the input optical fiber and the output optical fiber are respectively reflected from the first optical fiber Bragg grating and the second optical fiber Bragg grating toward the optical amplifier, and the first optical fiber Bragg grating and the second optical fiber Bragg grating respectively have a central wavelength and a reflection bandwidth different from each other.

12. The gain-clamped optical amplifier of claim 11, wherein the first optical fiber Bragg grating and the second optical fiber Bragg grating are respectively one or more installed optical fiber Bragg gratings.

13. The gain-clamped optical amplifier of claim 11, wherein the first optical fiber Bragg grating and the second optical fiber Bragg grating are respectively one or more waveguide type Bragg gratings directly engraved on each of an input optical waveguide and an output optical waveguide of the optical amplifier.

14. The gain-clamped optical amplifier of claim 11, wherein the first optical fiber Bragg grating or the second optical fiber Bragg grating uses an optical fiber having a section thereof coated for anti-reflection.

15. The gain-clamped optical amplifier of claim 11, wherein the first optical fiber Bragg grating and the second optical fiber Bragg grating uses an optical fiber having a core section of the optical fiber cut slantingly.

16. A gain-clamped optical amplifier, comprising:
optical reflection means provided at a side wall of any one of an input side and an output side of an optical amplifier;
optical anti-reflection means provided at an opposite side wall to the side wall having the optical reflection means; and
the optical amplifier disposed between the optical reflection means and the optical anti-reflection means, for amplifying an input optical signal or an output optical signal,
wherein the optical reflection means reflects an amplified spontaneous emission light emitted from the optical amplifier to the input and output sides, on the optical amplifier for amplification.

17. The gain-clamped optical amplifier of claim 16, wherein the optical reflection means and the optical anti-reflection means respectively are a wavelength selection reflective mirror and an anti-reflective thin film that are respectively coated on the side walls of the input and output sides of the optical amplifier.
